(19) United States
(12) Patent Application Publication
(10) Pub. No.: US 2022/0015194 A1
(43) Pub. Date: Jan. 13, 2022

(54) Snow Sensor with High Drainage Performance

(71) Applicant: nVent Services GmbH, Schaffthausen (CH)

(72) Inventors: Ivy Meng, Suzhou (CN); Daisy Zhang, Suzhou (CN); Amy Zhang, Suzhou (CN); Hector Liang, Suzhou (CN); Heaven Gu, Suzhou (CN); Nithin Hegde, Mumbai (IN)

(21) Appl. No.: 17/371,912

(22) Filed: Jul. 9, 2021

Related U.S. Application Data
(60) Provisional application No. 63/049,837, filed on Jul. 9, 2020.

(51) Int. Cl. H05B 1/02; F16M 11/22; G01K 3/00

(52) U.S. Cl. CPC H05B 1/0252; E01H 5/10; G01K 3/005; F16M 11/22

(57) ABSTRACT

A snow melting system and method for operating a snow sensor is provided. The snow melting system includes a controller, a heating system, and a snow sensor. The snow sensor comprises a support structure and a cap. The support structure includes a proximal end and a distal end, where a first plane defined by the distal end is angled with respect to a second plane defined by the proximal end. The cap is disposed at the distal end of the support structure and comprises a top surface, a side surface arranged orthogonal to the top surface, and a chamfer that extends between the side surface and the top surface.

### RELATED APPLICATIONS

This application is based on, claims priority to, and incorporates herein by reference in its entirety, U.S. Provisional Application Ser. No. 63/049,837, filed Jul. 9, 2020, and entitled “Snow Sensor With High Drainage Performance.”

### BACKGROUND

Conventional snow melting systems utilize heating devices in order to melt snow that can accumulate on surfaces such as driveways, walkways, stairs, patios, roofs, and the like. In order to automatically activate such heating devices without the need for manual input, a snow sensor can be included in such systems, which can detect when snow is accumulating in the area of the system. Conventional snow sensors generally provide a surface on which snow can collect, and activate on-board heating devices in order to melt the collected snow. A temperature sensor included in a conventional snow sensor can detect the melting of the snow to confirm that snow is accumulating in the area of the system.

However, water from the melted snow can collect on the surface of the conventional snow sensor, which can interfere with subsequent snow sensing operations performed by the snow sensor.

### SUMMARY

In some embodiments, a snow melting system is provided. The snow melting system includes a controller, a heating system, and a snow sensor. The snow sensor comprises a support structure and a cap. The support structure includes a proximal end and a distal end, where a first plane defined by the distal end is angled with respect to a second plane defined by the proximal end. The cap is disposed at the distal end of the support structure and comprises a top surface, a side surface arranged orthogonal to the top surface, and a chamfer that extends between the side surface and the top surface.

In some embodiments, a snow sensor is provided, comprising a support structure and a cap. The support structure includes a proximal end and a distal end, and an opening at the distal end. The cap covers the opening at the distal end of the support structure and includes a top surface, a side surface, and a chamfer that extends between the side surface and the top surface.

In some embodiments, a method of operating a snow sensor is provided, the snow sensor having a cap coupled to a support structure and the cap comprising a flat top surface, a side surface orthogonal to the cap, and a chamfer extending between the flat top surface and the side surface. The method includes arranging the snow sensor on a mounting surface so that the flat top surface of the cap is angled relative to the mounting surface, monitoring a first temperature, and activating heating elements of the snow sensor for a first time period when the first temperature is less than a first temperature threshold. The method also includes monitoring a second temperature of the cap during the first time period, indicating that snow is detected on the flat top surface of the cap when the second temperature is less than a second temperature threshold, and reactivating the heating elements to melt the snow on the flat top surface. The method further includes allowing the melted snow to run off the snow sensor by running off the flat top surface across the chamfer, and across the side surface.

### DESCRIPTION OF THE DRAWINGS

FIG. 1 is a block diagram of a snow melting system according to some embodiments.

FIG. 2A is a side view of a snow sensor having high drainage performance according to some embodiments.

FIG. 2B is a cross-sectional view of the snow sensor of FIG. 2A.

FIG. 2C shows a perspective view of a metal cap of the snow sensor of FIG. 2A.

FIG. 3 is an illustrative timing diagram, according to some embodiments, for a control signal of a snow sensor when low temperatures are detected, but snow is not detected.

FIG. 4 is an illustrative timing diagram, according to some embodiments, for a control signal of a snow sensor when both low temperatures and snow are detected by the snow sensor.

FIG. 5 is a flow chart for operating a snow sensor according to some embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

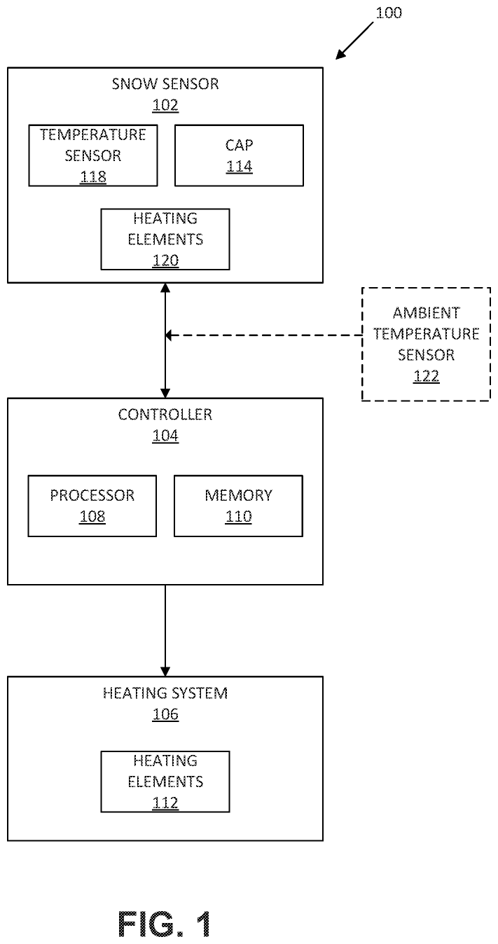

FIG. 1 illustrates a snow melting system 100 according to some embodiments. As will be described in detail below, the snow melting system 100 can include a snow sensor 102, a controller 104, and a heating system 106. Generally, in some embodiments, the controller 104 can communicate with the snow sensor 102 and send control signals to the heating system 106 to selectively activate or deactivate the heating system 106 based on whether snow has been detected by the snow sensor 102.

In some embodiments, the controller 104 can include a processor 108 coupled to a memory 110. In some embodiments, the memory 110 can include flash memory. In some embodiments, the processor 108 can execute computer readable instructions stored on the memory 110, for example, to receive inputs from and control the snow sensor 102, and/or control the heating system 106. Furthermore, in some embodiments, the processor 108 can retrieved stored values from the memory 110, such as predetermined time periods, temperature thresholds, etc., and/or access equations or look-up tables stored in the memory 110 to determined dynamic time periods.

In some embodiments, the heating system 106 can include one or more heating elements 112, such as heating mats and/or heating cables. For example, the heating system 106 and, more specifically, the heating elements 112 can be disposed on surfaces of roofs, stairs, driveways, sidewalks, patios, roadways, cycle-ways, and/or any other applicable surfaces on which snow or ice can accumulate. In some embodiments, the heating elements 112 can be electrically coupled to the controller 104 and controlled by the controller 104 (e.g., activated or “on”, deactivated or “off). According to one example, when activated, the heating elements 112 of the heating system 106 can be supplied with power or electricity, causing the mats and/or cables to increase in temperature, causing accumulated ice and/or snow in the immediate area to melt. According to another example, the controller 104 can activate one or more of the heating elements 112 by supplying power at different levels to provide different levels of heating.

In some embodiments, the snow sensor 102 can be an aerial snow sensor that is mounted in the general vicinity of the heating system 106. Generally, the snow sensor 102 can be used to detect snowfall such that, upon such detection, the controller 104 can activate the heating system 106. More specifically, the controller 104 can be configured to control the heating system 106 based on one or more temperature measurements received by the snow sensor 102 after heating the snow sensor 102. For example, in some embodiments, the snow sensor 102 can include a top cap 114, an integrated temperature sensor 118, and one or more heating elements 120. The cap 114 provides a surface that can receive snow. The temperature sensor 118 can be configured to monitor a temperature at the cap 114. In some embodiments, temperature measurements sensed by the temperature sensor 118 can be electronically communicated to the controller 104 via a wired or wireless connection. Furthermore, the cap 114 is thermally coupled to the heating elements 120, which can be controlled by the controller 104 to heat the cap 114. Accordingly, the controller 104 can be configured to control the heating system 106 based on a temperature measurement received by the temperature sensor 118 after heating the cap 114 via the heating elements 120.

Additionally, in some embodiments, the system 100 can include a second temperature sensor 122 (e.g., as part of the snow sensor 102, as part of the controller 104, or as a separate, individual component in communication with the snow sensor 102 and/or the controller 104) configured to measure an ambient temperature adjacent the snow sensor 102, the controller 104, and/or the heating system 106. However, in other embodiments, the temperature sensor 118 of the snow sensor 102 can measure ambient temperature. In some embodiments, the controller 104 can control the heating elements 120 based on the temperature measurements (e.g., from the temperature sensor 118), ambient temperature measurements (e.g., from the temperature sensor 122 or the temperature sensor 118), and/or other snow presence information received from the snow sensor 102.

More specifically, if the ambient temperature measurements indicate that ambient temperature has dropped below a predefined threshold (e.g., around 5° C.), the controller 104 can activate the heating elements 120 of the snow sensor 102 for a predetermined heating time period. After the heating elements 120 have been activated for a predetermined heating time period, the controller 104 can deactivate the heating elements 120 for a predetermined cooling time period. The temperature sensor 118 can measure the temperature at the cap 114 during the predetermined heating time period and/or the predetermined cooling time period, and can communicate corresponding temperature measurements, e.g., periodically, to the controller 104 throughout such periods.

If, during the predetermined heating time period, snow falls onto the surface of the cap 114, the temperature of the cap 114 will not reach an expected level. Thus, if the temperature measurement, sensed by the temperature sensor 118, drops below a set temperature value, the controller 104 can determine that snow has been detected by the snow sensor 102. For example, the controller 104 can set a flag or other indicator in the memory 110 to indicate such snow detection. Furthermore, in some embodiments, in response to the flag or other indicator being set by the controller 104, i.e., indicating snowfall detection, the controller 104 can cause the heating system 106 to be activated.

It should be noted that, in some embodiments, the snow sensor 102 can include a dedicated controller (not shown) in communication with the controller 104. The controller of the snow sensor 102 can be configured to perform one of more of the functions of the controller 104 described herein, such as receiving and analyzing the temperature measurements from the temperature sensor 118 or ambient temperature measurements, activating and deactivating the heating elements 120, and/or indicating snow fall detection to the controller 104.

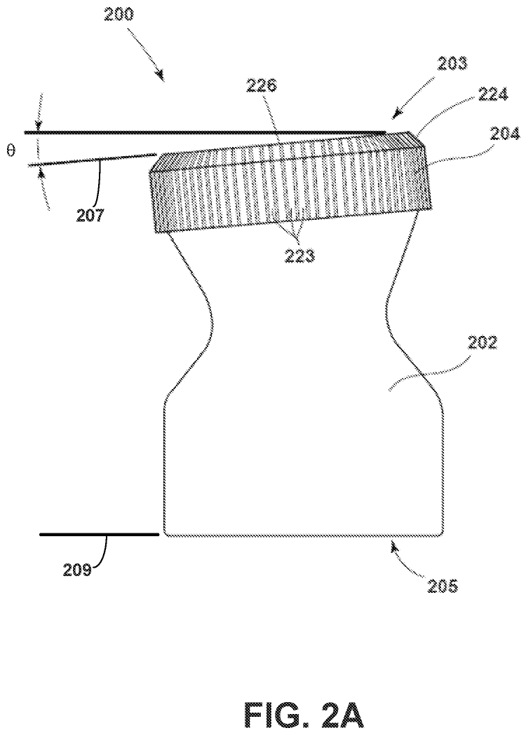

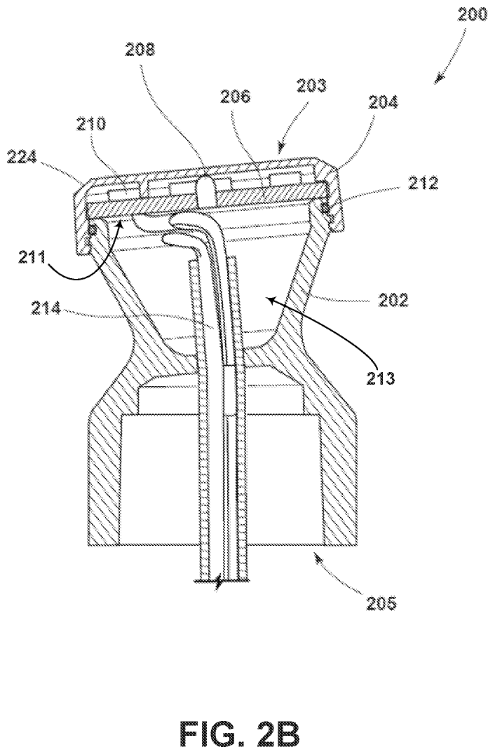

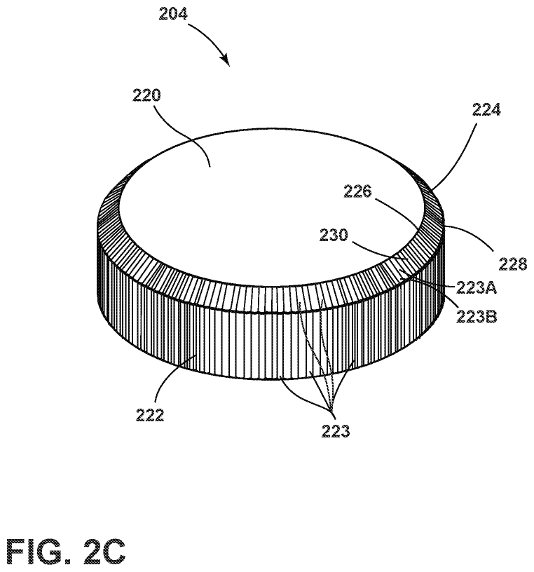

FIGS. 2A and 2B illustrate a snow sensor 200, according to some embodiments, that can be used in a snow melting system. For example, in some embodiments, the snow sensor 200 can be used as the snow sensor 102 of the snow melting system 100 of FIG. 1. FIG. 2A illustrates a side view of the snow sensor 200. FIG. 2B illustrates a cross-sectional view of the snow sensor 200. In order to detect snow fall, and ensure accuracy of subsequent detections, the snow sensor 200 can include a number of features to melt detected snow and drain the melted snow off of the snow sensor 200, as described in more detail below.

In some embodiments, the snow sensor 200 can include a support structure 202 and a cap 204. The support structure 202 can include a distal end 203 and a proximal end 205. The distal end 203 and the proximal end 205 can be arranged relative to each other so that a top plane 207 defined by the distal end 203 is tilted with respect to a bottom plane 209 defined by the proximal end 205 by an angle θ, such as about 5 degrees. For example, snow sensor 200 can be arranged so that the proximal end 205 can rest upon a flat mounting surface (not shown), where the bottom plane 209 is parallel to the mounting surface (e.g., horizontal) and the top plane 207 is angled relative to the mounting surface. Additionally, in some embodiments, a distal portion of the support structure 202 (e.g., the portion that includes the distal end 203) can be substantially funnel-shaped, as shown in FIGS. 2A and 2B, which can reduce the likelihood of icicle formation on the support structure 202. Furthermore, in some embodiments, the support structure 202 can be non-metallic.

The cap 204 can be coupled to the distal end 203 of the support structure 202 and can receive snowfall thereupon, as further described below. For example, the distal end 203 of the support structure 202 can include an opening 211 (shown in FIG. 2B), and the cap 204 can cover the opening 211 of the distal end 203. In some embodiments, the distal end 203 of the support structure 202 can include threads (not shown) that are dimensioned to fit into grooves included on interior walls of the cap 204, such that the cap 204 can be coupled to (e.g., screwed onto) the distal end 203. In other embodiments, the distal end 203 of the support structure 202 can instead connect to the cap 204 using a snap-fit connection.

Because the cap 204 covers the opening 211 of the support structure 202 at the distal end 203, any snowfall onto the cap 204 will run off the cap 204 around the support structure 202, rather than into the support structure 202. More specifically, as shown in FIGS. 2A, 2B, and 2C, the cap 204 can include a top surface 220 that can receive snow, an exterior side surface or side wall 222, and a chamfer 224 between the top surface 220 and the side wall 222. Following snow fall, snow that had landed on the top surface 220 and then melted can flow from the top surface 220, across the chamfer 224, and across the side wall 222. For example, due to the cap 204 being coupled to the distal end 203 of the support structure 202, the top surface 220 can be substantially parallel to the top plane 207 of the distal end 203 (i.e., arranged at an angle relative to the bottom plane 209 of the proximal end 205 or a mounting surface upon which the snow sensor 200 is set). As a result, the angled top surface 220 can allow water (i.e., snow that had landed on the top surface 220 and then melted) to better flow off of the top surface 220 compared to, for example, a flat top surface where water tends to remain on such a surface. In other words, the angled top surface 220 can generate a downward flow trend of water off of the top surface 220.

In some embodiments, the cap 204 can be made of a metal material, such aluminum, copper, or steel, which may be heated to melt accumulated snow and to initiate a snow detection process, as further described below. In some embodiments, the cap 204 can be made of a metal material having a relatively high thermal conductivity, such as aluminum or copper. Additionally, in some embodiments, the top surface 220 can be substantially flat and smooth. For example, the top surface can be polished, and can have an arithmetic average roughness (Ra) of less than about 0.4 micrometers (μm). The smoothness of the top surface 220 can reduce surface energy at the top surface 220, thus reducing the hydrophilicity of the metal of the top surface 220. As a result, surface tension of the top surface 220 can be reduced compared to unpolished or unsmooth top surfaces, so that water (i.e., melted snow) can better drain off of the polished top surface 220. Furthermore, in some embodiments, the top surface 220 can be substantially circular.

As shown in FIGS. 2A-2C, the chamfer can extend between the top surface 220 and the side wall 222. For example, in some embodiments, the top surface 220 can be arranged generally orthogonally to the side wall 222 such that the chamfer 224 provides an angled surface between the top surface 220 and the side wall 222. The chamfer can further assist the downward flow of water off of the top surface 220 when the cap 204 is installed on the support structure 202, improving drainage, by providing an angled edge between the top surface 220 and the side wall 222 rather than a traditional 90-degree transition.

More specifically, referring to FIG. 2C, the chamfer 224 can include a flat portion 230, a first corner radius 226, and a second corner radius 228. The first corner radius 226 defines the transition between the flat portion 230 and the top surface 220, and the second corner radius 228 defines the transition between the flat portion 230 and the exterior side wall 222. In some embodiments, the first corner radius 226 can define an angle of about 45° between the flat 230 and the top surface 220, and the second corner radius 228 can define about a 45° angle between the flat 230 and the side wall 222. In further embodiments, the first corner radius 226 can define an angle selected from about 30° to about 60°, inclusive, between the flat portion 230 and the top surface 220. For example, the corner radius 226 can define an angle of about 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, and/or 60° between the flat portion 230 and the top surface 220. The second corner radius 228 can define an angle selected from about 30° to about 60°, inclusive, between the flat portion 230 and the side wall 222. For example, the second corner radius 228 can define an angle of about 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, and/or 60° between the flat portion 230 and the side wall 222. In yet further embodiments, the first corner radius 226 and/or the second corner radius 228 can define an angle less than about 90°.

In some embodiments, the flat portion 230 can be about 1.55 mm in width, measured from the point at which the flat portion 230 meets the top surface 220 to the point at which the flat portion 230 meets the side wall 222. For example, when the angle between the flat portion 230 and the top surface 220 is about 45°, the flat 230 can be about 1.55 mm in width.

In some embodiments, the cap 204 can include a number of grooves 223 formed on at least one surface of the cap 204. In some embodiments, the cap 204 can include a plurality of grooves 223 formed on the chamfer 224. More specifically, the grooves 223 can be formed on the flat portion 230 of the chamfer 224. Furthermore, in some embodiments, the cap 204 can include a plurality of grooves 223 formed on the side wall 222 such that the grooves 223 can extend vertically up the side wall 222 and continue onto the flat portion 230 of the chamfer 224, ending at the first corner radius 226. However, in further embodiments, the chamfer 224 or the side wall 222 may not include grooves and may instead be substantially smooth.

In some embodiments, the grooves 223 can be formed (e.g., machined), for example, by a knurling tool. In some embodiments, the grooves 223 can be present about the entire circumference of the exterior side wall 222 and/or the chamfer 224. In some embodiments, the grooves 223 can be substantially evenly spaced on the exterior side wall 222 and/or the chamfer 224. In some embodiments, the grooves 223 can be spaced on the exterior side wall 222 and/or the chamfer 224 with a pitch of about 0.5 mm. Grooves having a pitch of about 0.5 mm have been shown to protect against ice buildup compared to, for example, a flat surface. Specifically, the grooves 223 can break the surface tension of liquid (e.g., water resulting from melted snow or ice) that can accumulate on the top surface 220, which can allow the liquid to flow off of the cap 204 more easily.

In some embodiments, any given two adjacent grooves 223 can define a ridge interposed between that pair of grooves. For example, a first groove 223A and a second groove 223B disposed on the chamfer 224 can define a ridge therebetween. In some embodiments, the grooves 223 and corresponding ridges formed thereby can correspond with German standard RAA 05 DIN 82. In some embodiments, the grooves 223 can extend contiguously and collinearly from the side wall 222 onto the chamfer 224, while in other embodiments, a first subset of the grooves 223 on the surface of the side wall 222 can lack collinearity with a second subset of the grooves 223 on the surface of the chamfer 224 without impacting drainage performance.

Returning to the cross-sectional view of FIG. 2B, in some embodiments, the snow sensor 200 can further include, in addition to the cap 204 and the support structure 202, a printed circuit board 206, a temperature sensor 208 (or thermal sensor), one or more heating elements 210, a sealing ring 212, and wires 214. As shown, in some embodiments, the printed circuit board 206 can be disposed at the distal end 203 of the support structure 202 (e.g., adjacent the opening 211). In some embodiments, the heating elements 210 and the temperature sensor 208 can be included on the printed circuit board 206.

In some embodiments, the wires 214 can pass through a hollow interior portion 213 of the support structure 202. In some embodiments, the wires 214 can be electrically coupled to the heating elements 210 and the temperature sensor 208 via the printed circuit board 206 (e.g., via electrically conductive traces printed on the printed circuit board 206). In some embodiments, the wires 214 can electrically connect the printed circuit board 206 and its constituent components to a controller (e.g., the controller 104 of FIG. 1).

In some embodiments, the temperature sensor 208 can be in direct physical contact and/or thermal contact with the cap 204, and can periodically measure the temperature of the cap 204 to produce measured temperature values. Measurements of the temperature of the cap 204 by the temperature sensor 208 when no heat has recently been applied to the cap 204 using the resistive heating elements 210 can effectively be considered herein to be ambient temperature measurements. In some embodiments, the temperature sensor 208 can send temperature data that includes measured temperature values generated by the temperature sensor 208 to the controller 104 via the wires 214.

In some embodiments, the heating elements 210 can be configured to heat the cap 204 when activated. The heating elements 210 can be resistive heating elements and/or any other applicable type of heating elements. For example, in some embodiments, control signals received via the wires 214 (e.g., from the controller 104) can control the activation or deactivation of the heating elements 210. More specifically, the heating elements 210 can be selectively activated or deactivated via the selective application of power to the heating elements 210 via control signals (e.g., sent by the controller 104) to the printed circuit board 206. In some embodiments, a single control signal can be used to activate all of the heating elements 210 simultaneously. Furthermore, in some embodiments, the heating elements 210 can be connected in series. In some embodiments, the heating elements 210 can be in direct physical and thermal contact with the cap 204. In some alternative embodiments, the heating elements 210 can be in indirect physical and thermal contact with the cap 204 via a high-thermal-conductivity material (such as thermal glue or thermal paste), which can be electrically insulating, and which can be interposed between and in contact with each of the heating elements 210 and the cap 204.

Referring still to FIG. 2C, the sealing ring 212 can provide a seal between the cap 204 and the support structure 202 and, thus, can prevent liquid from entering the area containing the printed circuit board 206. In some embodiments, the sealing ring 212 can be made of Polytetrafluoroethylene (PTFE), Nitrile, Neoprene, rubber, fluorocarbon, or silicone material, for example.

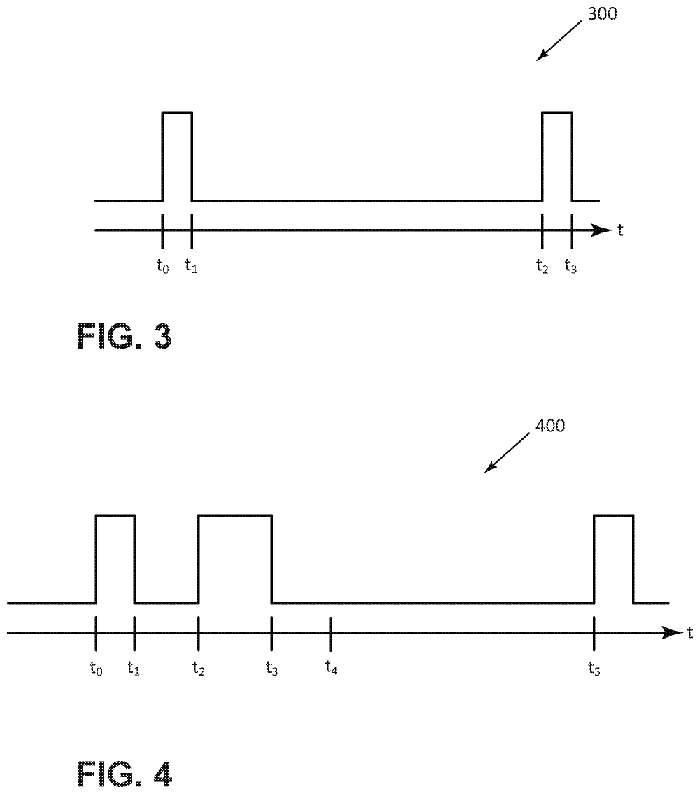

FIGS. 3 and 4 illustrate heating cycles for a snow sensor 102, 200, where FIG. 3 illustrates a cycle when snow is not detected by the snow sensor 102, 200 and FIG. 4 illustrates a cycle when snow is detected by the snow sensor 102, 200. The depicted signal represents whether resistive heating elements 120, 210 of the snow sensor 102, 200 are active (high, in a heating state) or inactive (low, in a passive state). The heating cycles of FIGS. 3 and 4 will be described below with respect to cycles of the snow sensor 102 of FIG. 1 or the snow sensor 200 of FIGS. 2A-2B, and the controller 104 of FIG. 1, though may represent cycles of other snow sensors and controllers not specifically described herein.

With respect to FIG. 3 (i.e., when snow is not detected), at time t₀, the controller 104 can determine that the ambient temperature is below a predetermined ambient temperature threshold (e.g., around 5° C.). As described above, the ambient temperature may be received from the internal temperature sensor 118, 208 of the snow sensor 102, 200 or an external ambient temperature sensor 122 of the system 100. In response to determining the ambient temperature below a threshold, the controller 104 can control the snow sensor 102, 200 (e.g., via one or more control signals) to activate the resistive heating elements 120, 210 of the snow sensor 102, 200 at a set, constant power. In some embodiments, the power level can be about 6 Watts (W). In some embodiments, the amount of constant power applied to the resistive heating elements 120, 210 can be selected based on the ambient temperature (e.g., based on a look-up table stored in a memory 110 of the controller 104 that defines relationships between ambient temperatures and constant power values for the resistive heating elements 120, 210). For example, in some embodiments, the power level can be set at about 6 W for temperatures down to about −5° C. and around 8 W for temperatures from about −5 ° C. down to about −20° C.

At time t₁, the controller 104 can control the snow sensor 102, 200 (e.g., via one or more control signals) to deactivate the resistive heating elements 120, 210. More specifically, the controller 104 can cause the snow sensor 102, 200 to deactivate the resistive heating elements 120, 210 upon determining that a predetermined heating time period has elapsed (e.g., from time t₀ to time t₁, around one minute in some embodiments). During the heating time period between time t₀ and time t₁, the controller 104 can continue to receive temperature data from the snow sensor 102, 200, corresponding to the temperature of a metal cap 204 of the snow sensor 200. The controller 104 then determines, based on the temperature data, that the maximum/highest temperature of the metal cap 204 measured during the period between time t₀ and time t₁ meets or exceeds a predetermined threshold (e.g., around 25° C.). Based on this determination that the maximum cap temperature has reached the temperature threshold during heating, the controller 104 determines that snow has not been detected by the snow sensor 102, 200.

The controller 104 then waits for a predetermined wait time period to elapse (e.g., from time t₁ to time t₂, about 20 minutes in some embodiments) before evaluating the ambient temperature at the snow sensor 102, 200 again. This wait time period can allow the snow sensor 102, 200 to cool down following activation of the resistive heating elements 120, 210. At time t₂, the cycle repeats, with the controller 104 again determining that the ambient temperature is less than the predetermined ambient temperature threshold, causing the resistive heating elements 120, 210 of the snow sensor 102, 200 to activate for the predetermined heating time period (i.e., from time t₂ to time t₃) and deactivating the resistive heating elements at time t₃.

With reference to FIG. 4 (i.e., when snow is detected), at time t₀, the controller 104 can determine that the ambient temperature is below a predetermined ambient temperature threshold (e.g., around 5° C.). As described above, the ambient temperature may be received from the internal temperature sensor 118, 208 of the snow sensor 102, 200 or an external ambient temperature sensor 122 of the system 100. In response to the ambient temperature being below the threshold, the controller 104 can control the snow sensor 102, 200 (e.g., via one or more control signals) to activate the resistive heating elements 120, 210 of the snow sensor 102, 200.

At time t₁, the controller 104 can control the snow sensor 102, 200 (e.g., via one or more control signals) to deactivate the resistive heating elements 120, 210. More specifically, the controller 104 can cause the snow sensor 102, 200 to deactivate the resistive heating elements 120, 210 upon determining that a predetermined heating time period has elapsed (e.g., from time t₀ to time t₁, about one minute in some embodiments). During the heating time period between time t₀ and time t₁, the controller 104 can continue to receive temperature data from the snow sensor 102, 200, corresponding to the temperature of a metal cap 204 of the snow sensor 200. The controller 104 then determines, based on the temperature data, that the maximum/highest temperature of the metal cap 204 of the snow sensor 200 measured during the heating time period between time t₀ and time t₁ is less than a predetermined threshold (e.g., about 25° C.). Based on this determination, the controller 104 determines that snow has detected by the snow sensor 102, 200. The controller 104 can set an indicator or flag in memory 110 and/or can activate one or more corresponding signals (e.g., a control signal that activates one or more heating elements 112 of the heating system 106 in the vicinity of the snow sensor 102, 200 to initiate snow/ice melt at a desired surface) upon determining that snow has been detected.

Following time t₁, the controller 104 can deactivate the resistive heating elements 120, 210 of the snow sensor 102, 200 for a predetermined snow melt wait time period (e.g., from time t₁ to time t₂). At time t₂, the controller 104 can activate the resistive heating elements 120, 210 of the snow sensor for a predetermined snow melt heat time period (e.g., from time t₂ to time t₃). At time t₃, the controller 104 can again deactivate the resistive heating elements 120, 210 for a predetermined snow melt cool time (e.g., from time t₃ to time t₄). Any or each of the snow melt wait time, the snow melt heat time, and the snow melt cool time can be dynamic values that are set based on detected conditions, such as the maximum temperature measured at the snow sensor 102, 200 between time t₀ and time t₁, and/or the ambient temperature.

The resistive heating elements 120, 210 can remain inactive for an additional static predetermined wait time period (e.g., from time t₄ to time t₅) which can provide additional time for the snow sensor 102, 200 to cool down following activation of the resistive heating elements 120, 210. At time t₅, the controller can assess the ambient temperature to determine that the ambient temperature is less than the predetermined ambient temperature threshold, and the cycle can repeat.

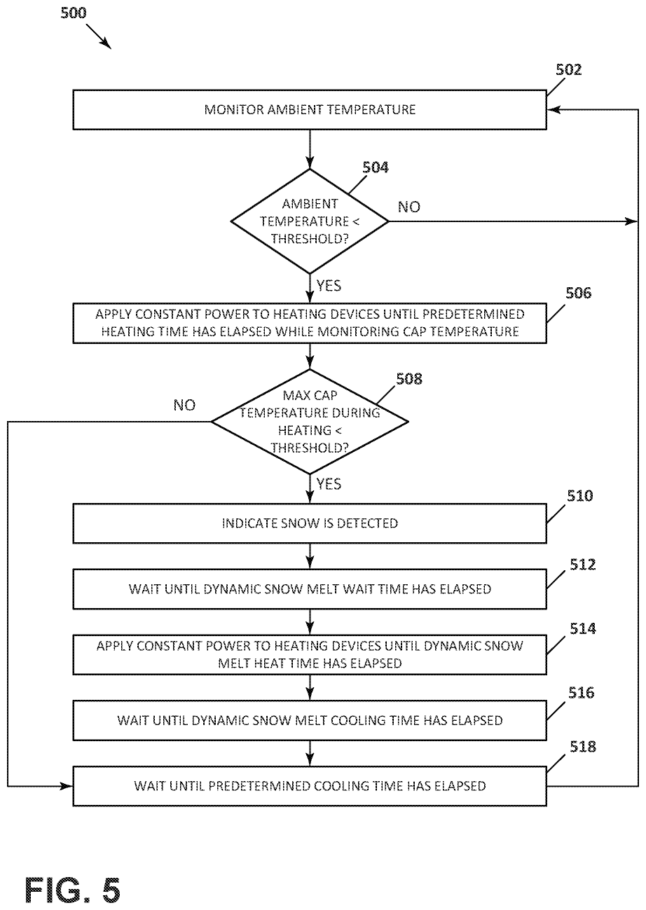

As another example, FIG. 5 illustrates a process 500 of operating a snow sensor according to some embodiments, such as the snow sensor 102 or 200 of FIGS. 1, 2A, and 2B. The process 500 can be performed by a controller, such as the controller 104 of FIG. 1, that is electrically coupled to the snow sensor 102, 200. More specifically, performance of the process 500 can be carried out via the execution of computer-readable instructions (e.g., instructions stored on the memory 110 of FIG. 1) by one or several computer processors (e.g., the processor 108 of FIG. 1) of the controller 104. Accordingly, the process 500 will be described below with respect to the snow sensor 102 of FIG. 1 or the snow sensor 200 of FIGS. 2A-2B, and the controller 104 of FIG. 1, though may be carried out by other controllers and/or other snow sensors not specifically described herein in some embodiments. Additionally, in some embodiments, the process 500 may be carried out by more than one controller, such as some steps carried out by the controller 104 and other steps carried out by an integrated controller of the snow sensor 102, 200, or a different controller.

Initially, the snow sensor 102, 200 can be arranged on a mounting surface, for example, so that the top surface 220 of the cap 204 is angled (i.e., nonparallel) with respect to the mounting surface, as described above. Additionally, the snow sensor 102, 200 can be connected to the controller 104 (e.g., via the wires 214). The process 500 may then begin at step 502, where the controller 104 can monitor ambient temperature at the snow sensor 102, 200. For example, the controller 104 can receive ambient temperature data generated by or based on measurements taken by the temperature sensor 118, 208 of the snow sensor 102, 200 (or an external ambient temperature sensor 122). The controller 104 can analyze the ambient temperature data to determine the ambient temperature at the snow sensor.

At step 504, the controller 104 can compare the ambient temperature to a predetermined threshold. For example, the controller 104 can compare the ambient temperature derived from the temperature data to a predetermined ambient temperature threshold, which can be stored in a memory device 110 of the controller 104. If the ambient temperature exceeds the predetermined threshold, the controller 104 can return to step 502 and ambient temperature monitoring continues. If the ambient temperature is less than the predetermined threshold, the controller 104 can proceed to step 506.

At step 506, the controller 104 can cause constant power to be applied to heating elements 120, 210 of the snow sensor 102, 200, until a predetermined heating time period has elapsed, while the temperature of a cap 204 of the snow sensor 200 is monitored. For example, the controller 104 can cause constant power (e.g., around 6-8 W) to be applied to the resistive heating elements 120, 210 of the snow sensor 102, 200. In some embodiments, the value of the constant power applied can be selected by the controller 104 based on the ambient temperature measured at step 502 (e.g., with higher wattages being applied when colder ambient temperatures are detected, according to predetermined power/temperature associations sufficient to initiate snowmelt, stored in memory 110). Furthermore, referring still to step 506, the controller 104 can continue to receive temperature data from the temperature sensor 118, 208, though at this stage the temperature data represents the temperature of a metal cap 114, 204 of the snow sensor 102, 200 that is heated by the resistive heating elements 120, 210, rather than the ambient temperature.

At step 508, the process 500 can compare the maximum temperature measured at the cap 114, 204 (e.g., a “maximum cap temperature”) during the heating performed at step 506 to a predetermined heating temperature threshold (e.g., about 25° C.). For example, the controller 104 can analyze the temperature data received during step 506 to determine the maximum cap temperature, and can compare the maximum cap temperature to the predetermined heating temperature threshold, which can be stored in a memory device 110 of the controller 104. If the maximum cap temperature is less than the predetermined heating temperature threshold, then the controller 104 can proceed to step 510. Otherwise, if the maximum cap temperature is higher than the predetermined heating temperature threshold, then the controller 104 can proceed to step 518.

At step 510, the controller 104 can indicate that snow has been detected in response to determining that the maximum cap temperature is less than the predetermined heating temperature threshold. For example, the controller 104 can set an indicator (e.g., flag) in a memory device 110 of the controller 104 to indicate that snow has been detected. Additionally or alternatively at step 510, the controller 104 can initiate one or more control signals to activate one or more heating elements 112 (e.g., heating cables and/or heating mats) of a heating system 106 coupled to the controller 104. In this way, the controller 104 can initiate snow melt at a surface in the vicinity of the snow sensor 102, 200 in response to the detection of snow based on the temperature data received by the controller 104 from the snow sensor 102, 200.

Following step 510, the controller 104 can deactivate the resistive heating elements 120, 210 once the predetermined heating time period has elapsed. At step 512, the controller 104 can keep the resistive heating elements 120, 210 of the snow sensor 102, 200 inactive until a dynamic snow melt wait time period has elapsed. For example, the controller 104 can determine and set the dynamic snow melt wait time period based on the maximum cap temperature determined at step 506 and/or the ambient temperature determined at step 502. In some embodiments, the controller 104 can determine the dynamic snow melt wait time period using the maximum cap temperature and/or the ambient temperature based on calculations or look-up tables stored in memory 110.

At step 514, the controller 104 can reactivate the resistive heating elements 120, 210 of the snow sensor 102, 200 until a dynamic snow melt heat time period has elapsed. For example, the process 500 can determine the dynamic snow melt heat time period based on the maximum cap temperature determined at step 506 and/or the ambient temperature determined at step 502. In some embodiments, the controller 104 can determine the dynamic snow melt heat time period using the maximum cap temperature and/or the ambient temperature based on calculations or look-up tables stored in memory 110. By activating the resistive heating elements 120, 210 of the snow sensor 102, 200 for an additional time period at step 514, additional snow that may have accumulated on the snow sensor 102, 200 can be melted. Further, the melted snow can then be drained off of the surface (e.g., the top surface 220) of the cap 114, 204 of the snow sensor 102, 200. That is, during this snow melt heat time period (and during the snow melt wait time period at step 512), melted snow can run off snow sensor 200 by running off the flat top surface 220, across the chamfer 224, and across the side surface 222. In some embodiments, as described above, drainage of the melted snow can be facilitated by one or more features of the snow sensor 102, 200. For example, drainage of melted snow can be optimized by a tilt (e.g., of about 5°) of the cap 204 of the snow sensor 200 (due to the tilt of the distal end 203 of a support structure 202 with respect to its proximal end 205), by a chamfer 224 of the cap 204 creating an angled edge off of the flat top surface 220, by grooves 223 formed in a side wall 222 of the cap 204 and/or in the chamfer 224, and/or by the smoothness of the polished top surface 220 of the cap 204.

Following step 514, the controller 104 can deactivate the resistive heating elements 120, 210 once the dynamic snow melt heat time period has elapsed. At step 516, the controller 104 can keep the resistive heating elements 120, 210 of the snow sensor 102, 200 inactive until a dynamic snow melt cooling time period has elapsed. For example, the controller 104 can determine the dynamic snow melt cooling time period based on the maximum cap temperature determined at step 506 and/or the ambient temperature determined at step 502. In some embodiments, the controller 104 can determine the dynamic snow melt cooling time period using the maximum cap temperature and/or the ambient temperature based on calculations or look-up tables stored in memory 110.

Furthermore, at step 518, the controller 104 can keep the resistive heating elements 120, 210 of the snow sensor 102, 200 inactive until a predetermined cooling time period (e.g., around 20 minutes) has elapsed. Accordingly, the snow melt cooling time period from step 516 can be added to the predetermined cooling time period at step 518 to provide additional time for the cap 114, 204 of the snow sensor 102, 200 to cool following the additional heating performed at step 514. Following the predetermined cooling time period, the controller 104 can return to step 502.

With respect to time periods of the above process 500, some time periods are described above as being dynamic (e.g., changing based on a measured temperature of the cap 204 or ambient temperature) or predetermined (e.g., preset, not based on temperature measurements). All time periods may be stored in memory 110 of the controller 104, such as single, predetermined time periods or dynamic time periods stored as equations or look-up tables based on temperature measurements. In some embodiments, however, dynamic time periods described above may instead be single, predetermined time periods and predetermined time periods described above may instead by dynamic, changing time periods based on a variable such as temperature data.

In light of the above, some embodiments provide a snow sensor and method for a snow melting system with high drainage performance. The snow sensor may comprise one or more features that can reduce water retained on its surface by, for example, surface tension. For example, the snow sensor can optimize drainage of melted snow on a top sensing surface of a cap by arranging the sensing surface to be tilted at a small inclination angle (e.g., at about 5°), by a chamfer of the cap creating an angled edge off of the flat top surface, by grooves formed in a side wall of the cap and/or in the chamfer, and/or by polishing the top surface. The cap may be formed of metal, while the support structure may be non-metallic, reducing thermal conductivity issues and providing for more sensitive snow detection (e.g., due to minimum metal material). The minimal materials can also provide for convenient production, lower product price, and long effective service time (e.g., compared to snow sensors that require, for example hydrophobic coatings that can add extra costs, decrease thermal conductivity, and have a shorter service life).

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of any patent and publication cited herein is incorporated by reference, as if each such patent or publication were individually incorporated by reference herein. Various features and advantages of the invention are set forth in the following claims.

Additionally, the term “about,” as used herein, refers to variation in the numerical quantity that may occur, for example, through typical measuring and manufacturing procedures used for articles of footwear or other articles of manufacture that may include embodiments of the disclosure herein; through inadvertent error in these procedures; through differences in the manufacture, source, or purity of the ingredients used to make the compositions or mixtures or carry out the methods; and the like. Throughout the disclosure, the terms “about” and “approximately” refer to a range of values ±5% of the numeric value that the term precedes.

1. A snow melting system comprising:
a controller;
a heating system; and
a snow sensor comprising:
a support structure having a proximal end and a distal end, wherein a first plane defined by the distal end is angled with respect to a second plane defined by the proximal end, and
a cap disposed at the distal end of the support structure, the cap comprising:
a top surface,
a side surface arranged orthogonal to the top surface, and
a chamfer that extends between the side surface and the top surface.

2. The snow melting system of claim 1, wherein the chamfer comprises a plurality of grooves.

3. The snow melting system of claim 2, wherein the plurality of grooves are spaced on the chamfer with a pitch of about 0.5 mm.

4. The snow melting system of claim 2, wherein the chamfer comprises a flat exterior surface, and the plurality of grooves are arranged on the flat exterior surface.

5. The snow melting system of claim 4, wherein the chamfer comprises a corner radius defining an angle between the flat exterior surface and the top surface, the angle being between 30 degrees and 60 degrees.

6. The snow melting system of claim 2, wherein the side surface comprises a second plurality of grooves.

7. The snow melting system of claim 6, wherein the second plurality of grooves is collinear with respect to the plurality of grooves of the chamfer.

8. The snow melting system of claim 1, wherein the snow sensor further comprises a temperature sensor in communication with the controller.

9. The snow melting system of claim 8, wherein the snow sensor further comprises a heating element controlled by the controller to heat the cap.

10. The snow melting system of claim 9, wherein the controller is configured to control the heating system based on a temperature measurement received by the temperature sensor after heating the cap via the heating element.

11. A snow sensor comprising:
a support structure having a proximal end and a distal end, and an opening at the distal end; and
a cap covering the opening at the distal end of the support structure, the cap comprising:
a top surface,
a side surface, and
a chamfer that extends between the side surface and the top surface.

12. The snow sensor of claim 11, wherein the chamfer comprises a plurality of grooves.

13. The snow sensor of claim 12, wherein the plurality of grooves are spaced on the chamfer with a pitch of about 0.5 mm.

14. The snow sensor of claim 12, wherein the chamfer comprises a flat exterior surface, and the plurality of grooves are arranged on the flat exterior surface.

15. The snow sensor of claim 14, wherein the chamfer comprises a corner radius defining an angle between the flat exterior surface and the top surface, the angle being between about 30 degrees and about 60 degrees.

16. The snow sensor of claim 12, wherein the side surface comprises a second plurality of grooves.

17. The snow sensor of claim 16, wherein the second plurality of grooves is collinear with respect to the plurality of grooves of the chamfer.

18. The snow sensor of claim 11, wherein the cap is a metal cap.

19. A method of operating a snow sensor having a cap coupled to a support structure, the cap comprising a flat top surface, a side surface orthogonal to the cap, and a chamfer extending between the flat top surface and the side surface, the method comprising:
arranging the snow sensor on a mounting surface so that the flat top surface of the cap is angled relative to the mounting surface;
monitoring a first temperature;
activating heating elements of the snow sensor for a first time period when the first temperature is less than a first temperature threshold, the heating elements being thermally coupled to the cap;
monitoring a second temperature of the cap during the first time period;
indicating that snow is detected on the flat top surface of the cap when the second temperature is less than a second temperature threshold;
reactivating the heating elements to melt the snow on the flat top surface; and
allowing the melted snow to run off the snow sensor by running off the flat top surface across the chamfer, and across the side surface.

20. The method of claim 19 and further comprising polishing the flat top surface to an arithmetic average roughness of less than about 0.4 μm.
